(19) United States
(12) Patent Application Publication
(10) Pub. No.: US 2014/0077006 A1
(43) Pub. Date: Mar. 20, 2014

(54) Multi-Hole Nozzle and Components Thereof

(71) Applicant: The Procter & Gamble Company, Cincinnati, OH (US)

(72) Inventor: Eric Shawn Goudy, Liberty Township, OH (US)

(73) Assignee: The Procter & Gamble Company, Cincinnati, OH (US)

(21) Appl. No.: 14/028,877

(22) Filed: Sep. 17, 2013

Related U.S. Application Data
(60) Provisional application No. 61/703,401, filed on Sep. 20, 2012.
(60) Provisional application No. 61/713,696, filed on Oct. 15, 2012.

(51) Int. Cl. B05B 1/14

(52) U.S. Cl. CPC B05B 1/14
USPC 239/565

(57) ABSTRACT

A multi-hole nozzle component for a filling machine is described herein. The multi-hole nozzle component may be part of a nozzle assembly. The nozzle component has a periphery, an inlet side having a surface, and an outlet side having a surface. The nozzle component has a plurality of separate passageways extending through the nozzle component from adjacent its inlet side to its outlet side, wherein the passageways form a plurality of openings in the surface of the outlet side of the nozzle component. In one embodiment, the surface of the outlet side of the nozzle component has a plurality of grooves therein that are disposed to run between said openings in the surface of the outlet side of the nozzle component.

### FIELD OF THE INVENTION

A multi-hole nozzle and components thereof for a filling machine are described herein.

### BACKGROUND

Filling nozzles are described in the patent literature, including in the following patent publications: U.S. Pat. No. 4,512,379, Hennig; European Patent Application 0 278 560 (Shikoku Kakoki), published Aug. 17, 1988; U.S. Pat. No. 5,954,086, Ronchi; U.S. Pat. No. 7,000,656 B2, Todd; U.S. Pat. No. 7,958,910 B2, Nakamori; and FR2905121B1 (assigned to Pack Realisations).

The search for improved nozzles for filling machines has, however, continued. There is a need for nozzles for filling machines that are capable of quickly filling a succession of containers with liquid that avoid splashing of the liquid, and that are capable of cleanly shutting off the flow of liquid between containers to avoid dripping the liquid outside of the containers.

### SUMMARY

A multi-hole nozzle and components thereof for a filling machine are described herein. The multi-hole nozzle may comprise a nozzle component that may be part of a nozzle assembly. The nozzle component has a periphery, an inlet side having a surface, and an outlet side having a surface. The nozzle component has a plurality of separate passageways extending through the nozzle component from adjacent its inlet side to its outlet side, wherein the passageways form a plurality of openings in the surface of the outlet side of the nozzle component. In one embodiment, the surface of the outlet side of the nozzle component has a plurality of grooves therein that are disposed to run between the openings in the surface of the outlet side of the nozzle component.

### BRIEF DESCRIPTION OF THE DRAWINGS

FIG. 1 is a schematic side view of one embodiment of a filling nozzle.

FIG. 2 is a cross-sectional view of the filling nozzle shown in FIG. 1.

FIG. 3 is a perspective view of one embodiment of a nozzle component having centering elements thereon for centering the nozzle on the outside of the neck of a bottle.

FIG. 4 is a plan view of the surface of the outlet side of the nozzle component shown in FIG. 3, without the centering elements thereon.

FIG. 5 is a perspective view of an alternative nozzle component.

FIG. 6 is a perspective view of another alternative nozzle component.

FIG. 7 is a perspective view of another alternative nozzle component.

FIG. 8 is a perspective view of an alternative nozzle component having a centering feature that can be inserted into the mouth of a bottle.

FIG. 9 is a perspective view of one embodiment of a stopper for the filling nozzle.

### DETAILED DESCRIPTION

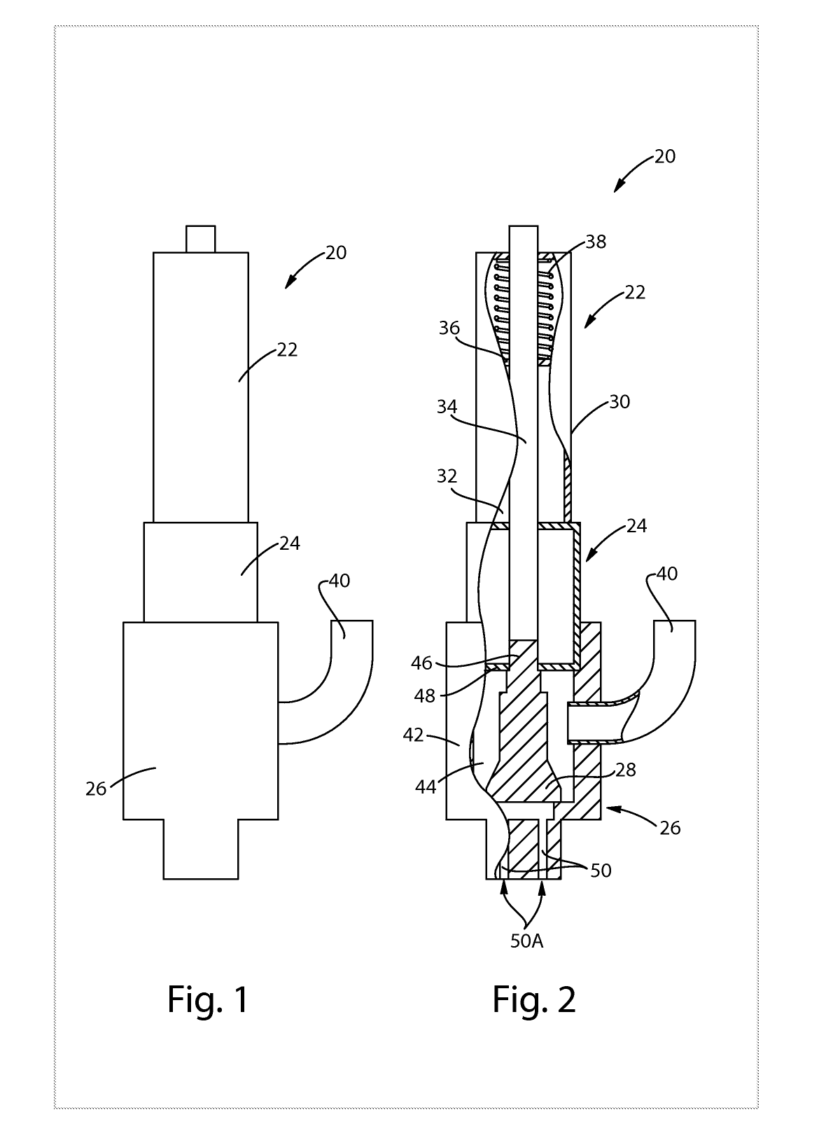

FIGS. 1 and 2 show one non-limiting example of a multi-hole nozzle assembly 20. FIG. 2 shows that the multi-hole nozzle assembly 20 may generally comprise an air cylinder 22, an optional connecting body 24, and a nozzle body 26. The air cylinder 22 moves the stopper 28 inside the nozzle body 26 to open and close the nozzle. The optional connecting body 24 connects the air cylinder 22 to the nozzle body 26. It should be understood that the nozzle body 26, or components thereof, may comprise inventions in their own right separate and apart from the nozzle assembly 20, and that the description of the nozzle assembly is provided to show these components in context.

FIG. 2 shows that the air cylinder 22 may comprise a housing 30 having an interior hollow space 32 therein. The air cylinder 22 further comprises a rod 34, a piston 36, and a spring 38. In its usual orientation, during operation, the air cylinder 22 will move the rod 34 upward in order to open the nozzle, and downward to close the nozzle. The spring 38 holds the stopper 28 against the openings in the nozzle body 26 and keeps liquid from running out of the nozzle in the event air pressure to the filling machine is turned off (for an emergency, maintenance, air tubing failure, etc). The air cylinder 22 may comprise any suitable commercially available air cylinder.

The optional connecting body 24 can comprise an element of any configuration that is suitable for connecting the air cylinder 22 to the nozzle body 26.

The nozzle body 26 is joined to the other portion(s) of the nozzle assembly 20, and forms the outlet of the nozzle assembly 20. The nozzle body 26 comprises a housing 42 and has at least one inlet conduit 40 joined thereto so that it is in liquid communication with the inner chamber 44 of the nozzle body 26. The nozzle assembly 20 may further comprise an optional stem 46 that is joined to the air cylinder rod 34. A flexible diaphragm 48 encircles at least a portion of the length of the air cylinder rod 34 or stem 46.

The nozzle body 26 has a plurality of spaced passageways 50 that pass through the nozzle body. The passageways 50 may be integrally formed in a portion of the nozzle body 26 itself, such as the housing 42, or the passageways 50 may be formed in a separate nozzle piece, such as an insert or an attachment, that it joined to the remainder of the nozzle body 26. For example, such a separate nozzle piece 52 may be removably affixed (such as by a clamp) to the nozzle body housing 42. The term “nozzle component” will be used herein to describe either of the following nozzle constructions: the portion of the nozzle body 26 that has the passageways 50 formed therein; or a separate nozzle piece that has the passageways 50 formed therein. The nozzle body 26 has a stopper 28 therein at the end of the air cylinder rod 34 or optional stem 46 for closing the passageways 50 and shutting off the nozzle.

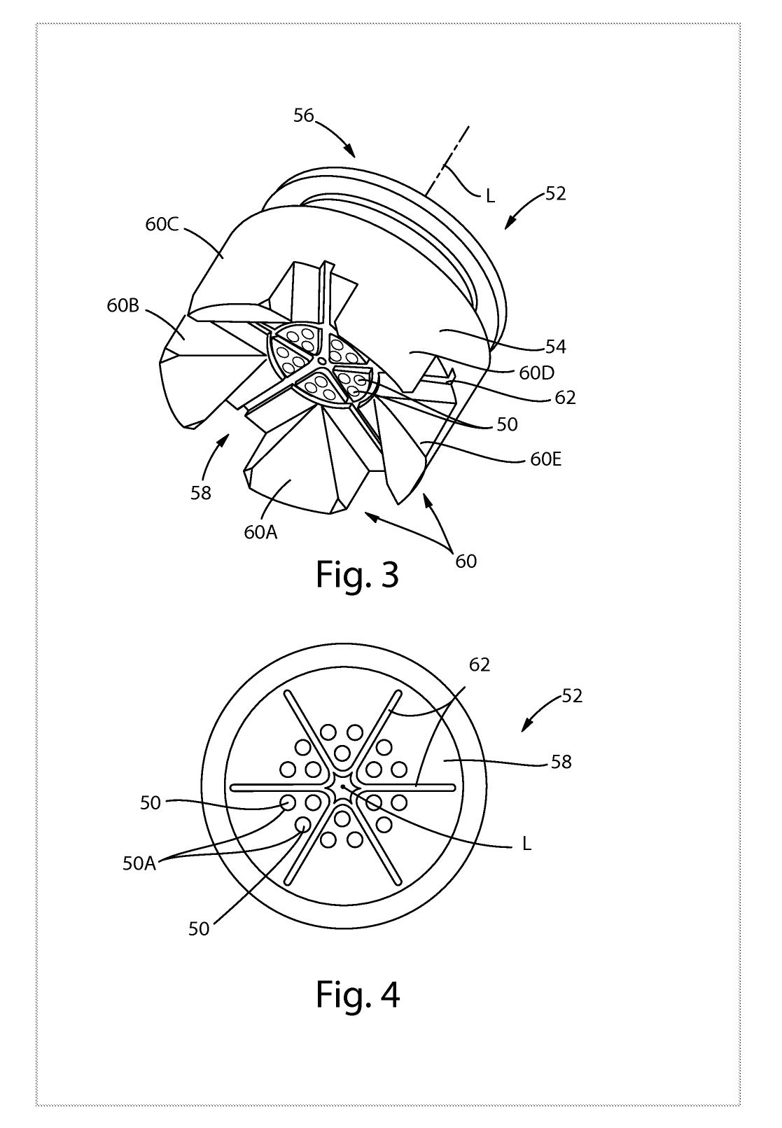

FIG. 3 shows one embodiment of a nozzle component 52, in the form of a nozzle piece, in greater detail. The nozzle component 52 has a periphery 54, an inlet side 56 having a surface, and an outlet side 58 having a surface. The nozzle component 52 has a centerline L extending from its inlet side to its outlet side. The nozzle component 52 comprises a plurality of separate spaced passageways 50 that extend through the nozzle component from adjacent its inlet side to its outlet side. In some embodiments, a plurality of the passageways 50 may be formed into the surface of the inlet side 56 of the nozzle component 52. In other embodiments, such as shown in FIG. 2, the inlet side 56 of the nozzle component 52 may have a single opening or recess (or, in some cases, more than one opening) formed therein. The recess may have a base (for example, it may form a shelf) adjacent the inlet side 56 of the nozzle component 52, and the plurality of passageways 50 may be formed in this shelf. The term “adjacent” is intended to cover both types of embodiments. The passageways 50, thus, may form a single, or a plurality of openings 50A in the inlet surface 56 of the nozzle component 52, and form a plurality of openings in the outlet side 58 of the nozzle component 52. It should be understood in instances when the nozzle body 26, or housing 42 thereof, comprises the nozzle component that has the passageways 50 formed therein, the nozzle body 26 (or housing 42 thereof) will have features that correspond to those described herein for the nozzle piece.

FIG. 3 shows that the nozzle component 52 further may comprise a centering feature 60 extending outwardly from the outlet side 58 thereof. The centering feature 60 is used to align the nozzle component with the neck of the bottles to be filled. In this embodiment, the centering feature 60 comprises several spaced apart centering elements 60A-60E that comprise extensions of the periphery 54 of the nozzle component. The centering elements 60A-60E have inner surfaces that are tapered so that they are wider at their base (or “proximal ends”) and narrower at their distal ends.

As shown in FIGS. 3 and 4, in some embodiments, the passageways 50 extending through the nozzle component 52 may be substantially parallel to each other, and may also be parallel to the centerline of the nozzle component 52. The passageways 50 may be of any suitable size and have any suitable cross-sectional configuration. The passageways 50 may all be of the same cross-sectional size, or they may have different cross-sectional sizes. Suitable cross-sectional configurations include, but are not limited to substantially circular cross-sections. The passageways 50 may be sized and configured so that when liquid is dispensed through the nozzle, the liquid exits the outlet side in the form of separate streams from each passageway 50.

As shown in FIGS. 3 and 4, the surface of the outlet side 58 of the nozzle component 52 may have a plurality of grooves 62 therein that are disposed to run between the openings 50A in the surface of the outlet side 58 of the nozzle component 58. The grooves 62 in the surface of the outlet side 58 of the nozzle component may be of any suitable configuration, and be arranged in any suitable pattern. The grooves 62 may be rectilinear, curvilinear, or combinations thereof. The grooves 62 may be sized and configured to reduce dripping of liquid from the passageways 50 after the nozzle is closed. The grooves 62 do this by separating the openings 50A on the outlet side 58 from each other so that any individual liquid meniscuses formed at the openings 50A on the outlet side of the nozzle component cannot combine to produce a large drop. The grooves 62 may, thus, at least partially surround the openings 50A to separate the openings from each other. The number of openings 50A that are separated from each other by the grooves 62 can range from one to six or more, depending on characteristics, such as viscosity, of the liquid being dispensed. While it is possible to separate passageways 50 by distances that are large enough to avoid any individual liquid meniscuses formed at the openings 50A on the outlet side of the nozzle component from combining to produce a large drop, the grooves 62 permit the passageways 50 to be located closer to each other without this occurring.

In the embodiment shown in FIGS. 3 and 4, the grooves 62 extend radially outward from the centerline L toward the periphery of the nozzle component. The grooves 62 may intersect with each other at the centerline L of the nozzle component. The grooves 62 may, but need not, extend all the way to the periphery of the nozzle component. In the particular embodiment shown, the grooves 62 separate the openings 50A into groups of three. In this embodiment, the openings 50A are about 2 to about 5 mm in diameter, and are spaced apart by a distance of 3.4 mm The grooves 62 are about 2 to about 4 mm in width, and about 2 mm deep.

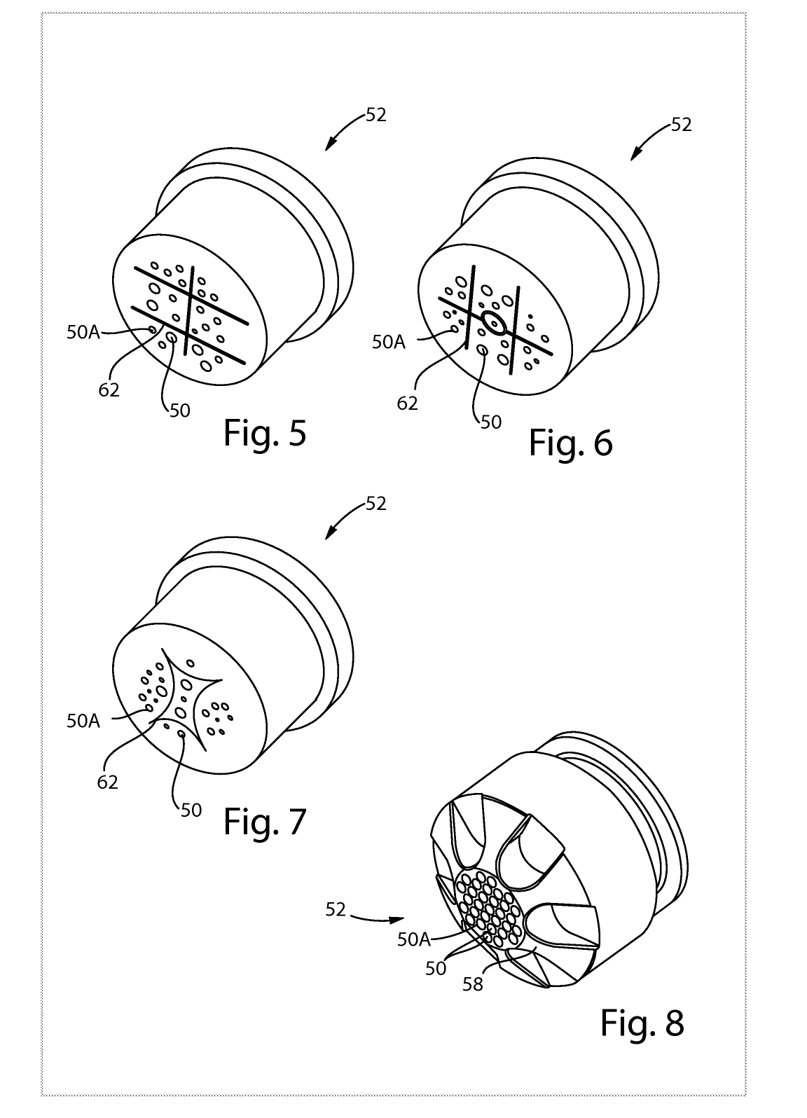

FIGS. 5 to 7 are non-limiting examples of several other possible nozzle passageway opening 50A and groove 62 configurations. These figures show that the openings 50A (and, thus the cross-sectional dimensions of the passageways) can be of different sizes, and that the grooves 62 that divide the openings 50A formed thereby can be arranged in many different patterns.

FIG. 8 shows that the outlet side 58 of the nozzle component 52 may have a configuration in which the central portion of the outlet side 58 of the nozzle component projects outward relative to the remainder of the outlet side 58. In the embodiment shown in FIG. 8, the configuration may be in the form of a truncated cone configuration, or other configuration. Some bottles are more amenable to centering by a nozzle component that extends from the center of the nozzle component. In this embodiment, the beveled portion can stick into the mouth of the bottle and center the bottle to the nozzle rather than centering by contacting the exterior of the bottle.

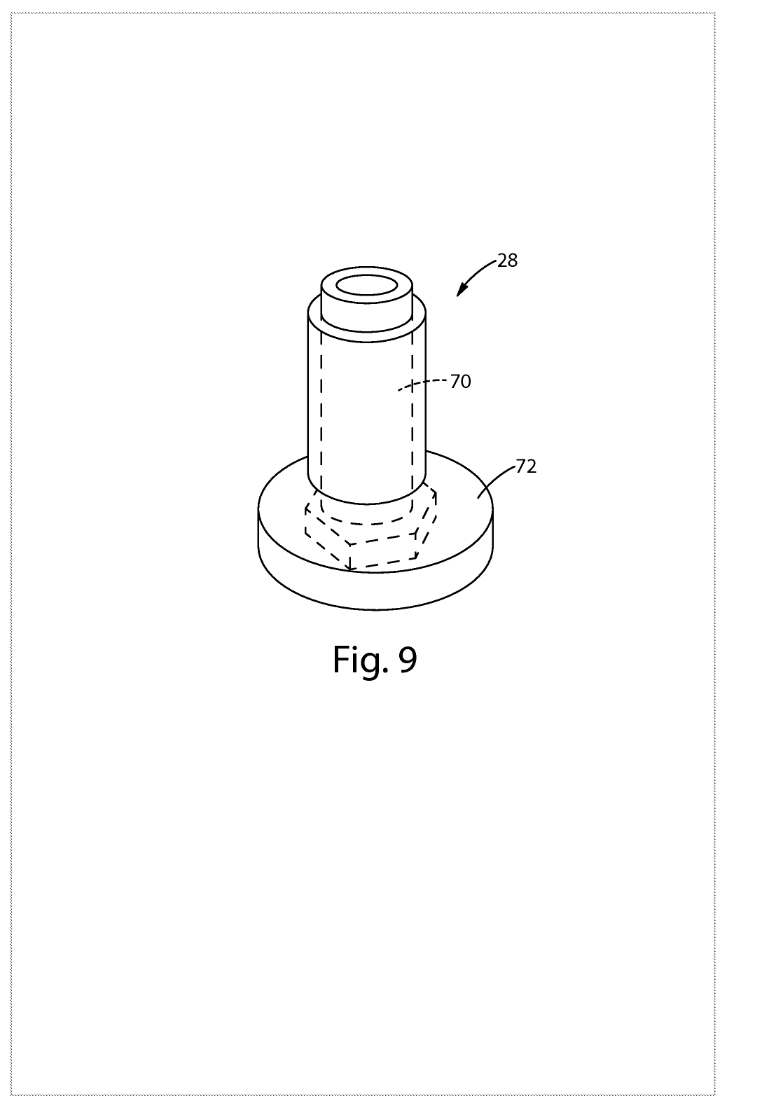

FIGS. 2 and 9 show one embodiment of a stopper 28 for the filling nozzle. The stopper 28 can be of any suitable configuration, and can be made of any suitable material(s). In the embodiment shown, the stopper 28 is configured to have a substantially flat distal end that is large enough to simultaneously cover all of the opening(s) formed by the passageways 50 in the inlet side 56 of the nozzle body. The stopper 28 can be made of a single material, such as stainless steel. In the embodiment shown in FIG. 9, the stopper 28 comprises a metal insert 70 and a compressible material 72 at least at the end thereof for shutting off the nozzle. As shown in FIGS. 2 and 9, the compressible material 72 may encase the metal insert 70.

The components of the multi-hole nozzle assembly 20 can be made in any suitable manner from any suitable materials. The various components (other than any compressible material used for the stopper) can be machined or cast from metal, such as stainless steel, or from plastic, or certain components may be made out of metal, and certain components may be made out of plastic.

The multi-hole nozzle assembly 20 functions as follows. The liquid to be filled into containers is delivered under pressure to the nozzle inlet 40. The air cylinder rod 34 is in the closed position. In this position, the liquid is contained inside the chamber 44 of the nozzle body 26. After a container is in position to be filled, the machine program sends a signal to a solenoid valve which shifts and sends air pressure to the air cylinder. The air cylinder rod 34 moves upward allowing the liquid to flow through the passageways 50 into the bottle. When the machine program detects the correct amount of fluid has been delivered to the container, a signal is sent to the solenoid valve which shifts and moves the air cylinder rod 34 downward closing off the passageways 50 and preventing any additional liquid from flowing out of the nozzle.

As used herein, the term “joined to” encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The term “joined to” encompasses configurations in which an element is secured to another element at selected locations, as well as configurations in which an element is completely secured to another element across the entire surface of one of the elements.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-hole nozzle component for a filling machine, said multi-hole nozzle component having a periphery, an inlet side having a surface, and an outlet side having a surface, said nozzle component further comprising a plurality of separate passageways extending through said nozzle component from adjacent its inlet side to its outlet side, wherein the passageways form a plurality of openings in the surface of the outlet side of the nozzle component, and the surface of the outlet side of said nozzle component has a plurality of grooves therein that are disposed to run between said openings in the surface of the outlet side of the nozzle component.

2. The multi-hole nozzle component of claim 1 wherein said passageways extending through said nozzle component are substantially parallel to each other.

3. The multi-hole nozzle component of claim 2 wherein said passageways have substantially circular cross-sections.

4. The multi-hole nozzle component of claim 1 wherein said passageways are sized and configured so that when liquid is dispensed through said nozzle, the liquid exits the outlet side in the form of separate streams from each passageway.

5. The multi-hole nozzle component of claim 1 wherein said grooves between the openings formed by the passageways in the surface of the outlet side of the nozzle component at least partially surround the openings to separate the openings from each other.

6. The multi-hole nozzle component of claim 5 wherein the number of openings that are separated from each other by the grooves can range from one to groups of six or more.

7. The multi-hole nozzle component of claim 5 wherein said nozzle component has a centerline extending from said inlet side to said outlet side, wherein said grooves in the surface of the outlet side of said nozzle component extend radially outward from said centerline toward the periphery of said nozzle component.

8. The multi-hole nozzle component of claim 7 wherein said grooves intersect with each other at said centerline.

9. The multi-hole nozzle component of claim 6 wherein said grooves are sized and configured to reduce dripping of liquid after the nozzle is closed by separating the openings on the outlet side from each other such that any individual meniscuses formed at the openings on the outlet side of the nozzle component cannot combine to produce a large drop.
